(19) United States
(12) Patent Application Publication
(10) Pub. No.: US 2014/0054817 A1
(43) Pub. Date: Feb. 27, 2014

(54) THREE-DIMENSIONAL PRINTER

(71) Applicant: MISSION STREET MANUFACTURING, INC., Santa Barbara, CA (US)

(72) Inventor: Brian H. Jaffe, Santa Barbara, CA (US)

(73) Assignee: MISSION STREET MANUFACTURING, INC., Santa Barbara, CA (US)

(21) Appl. No.: 13/969,175

(22) Filed: Aug. 16, 2013

Related U.S. Application Data
(60) Provisional application No. 61/728,640, filed on Nov. 20, 2012.
(60) Provisional application No. 61/692,965, filed on Aug. 24, 2012.

(51) Int. Cl. B29C 47/06

(52) U.S. Cl. CPC B29C 47/06
USPC 264/129; 425/375

(57) ABSTRACT

Embodiments provide a 3-dimensional (3D) printing device with a column, a climber attached to the column, and a beam attached to the climber such that the rectangular beam can angularly rotate with respect to the column. An extruder assembly may be coupled with the beam. In embodiments, the 3D printing device may be operable to move the extruder assembly in angular, radial, and vertical movement. In some embodiments, a plurality of 3D printing devices may be networked together.

### CROSS REFERENCE TO RELATED APPLICATIONS

The present application claims priority to U.S. Provisional Patent Application No. 61/692,965, filed Aug. 24, 2012, entitled “3D Printer,” and No. 61/728,640, filed Nov. 20, 2012, entitled “3D Printer,” the entire disclosures of which are hereby incorporated by reference in their entirety.

### TECHNICAL FIELD

Embodiments herein relate to a three-dimensional (3D) printing device.

### BACKGROUND

3D printing is a form of additive manufacturing whereby industrial or consumer parts may be manufactured by adhering multiple layers of material on top of one another with a high precision computer driven applicator. The end result may be a physical 3D part which may be identical or closely similar to a 3D model generated by Computer Aided Design (CAD) software or other 3D design software.

In many cases the material used for 3D printing may be plastic. Typically, the plastic may be introduced to an extruder assembly. The extruder assembly may be the part of the 3D printing device that moves to extrude the 3D printing material in the shape of whatever layer of the 3D printed part it is currently making. Specifically, at the extruder assembly, a continuous strand of solid plastic build material may be melted, and the liquid plastic falls on top of the previous layer of the part being made as directed by movement of the extruder assembly.

Typically, the extruder assembly applies the plastic in a single plane. Once it has left the heating element of the extruder assembly, the liquid plastic build material rapidly cools back into a solid state and in so doing adheres to the other plastic around it, forming a continuous, solid plastic part.

### BRIEF DESCRIPTION OF THE DRAWINGS

FIG. 1 depicts an example of a 3D printing device, in accordance with various embodiments.

FIG. 2 depicts a semi-transparent view of a 3D printing device, in accordance with various embodiments.

FIGS. 3-A, 3-B, and 3-C depict a semi-transparent view of a 3D printing device showing how an I-beam may laterally extend from the apparatus and move in the radial direction, in accordance with various embodiments.

FIGS. 4-A and 4-B depict a semi-transparent view of a 3D printing device showing how the apparatus rotates angularly, in accordance with various embodiments.

FIG. 5-A depicts a semi-transparent side view of another example of a 3D printing device, in accordance with various embodiments.

FIG. 5-B depicts another semi-transparent back view of another example of a 3D printing device, in accordance with various embodiments.

FIG. 6 depicts an example of a plurality of 3D printing devices constructing a single object, in accordance with various embodiments.

FIG. 7 depicts another example of a plurality of 3D printing devices constructing a single object, in accordance with various embodiments.

FIG. 8 is a flowchart depicting a process of printing using the 3D printing device, in accordance with various embodiments.

### DETAILED DESCRIPTION OF EMBODIMENTS OF THE INVENTION

In the following detailed description, reference is made to the accompanying drawings that form a part hereof, and in which are shown by way of illustration embodiments that may be practiced. It is to be understood that other embodiments may be utilized and structural or logical changes may be made without departing from the spirit or scope of the present disclosure. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous.

3D printing devices may be generally thought of as machines that may construct parts up to a maximum size, termed a build volume. For 3D printing devices currently on the market, the build volume may still only be a fraction of the size of the 3D printing device itself. This size of the build volume may be limited because existing 3D printing devices may generally be described as large boxes that can build parts fitting into much smaller virtual boxes inside them. By contrast, embodiments of 3D printing devices described herein may have a build volume greater than the size of the printer itself, such as many times greater.

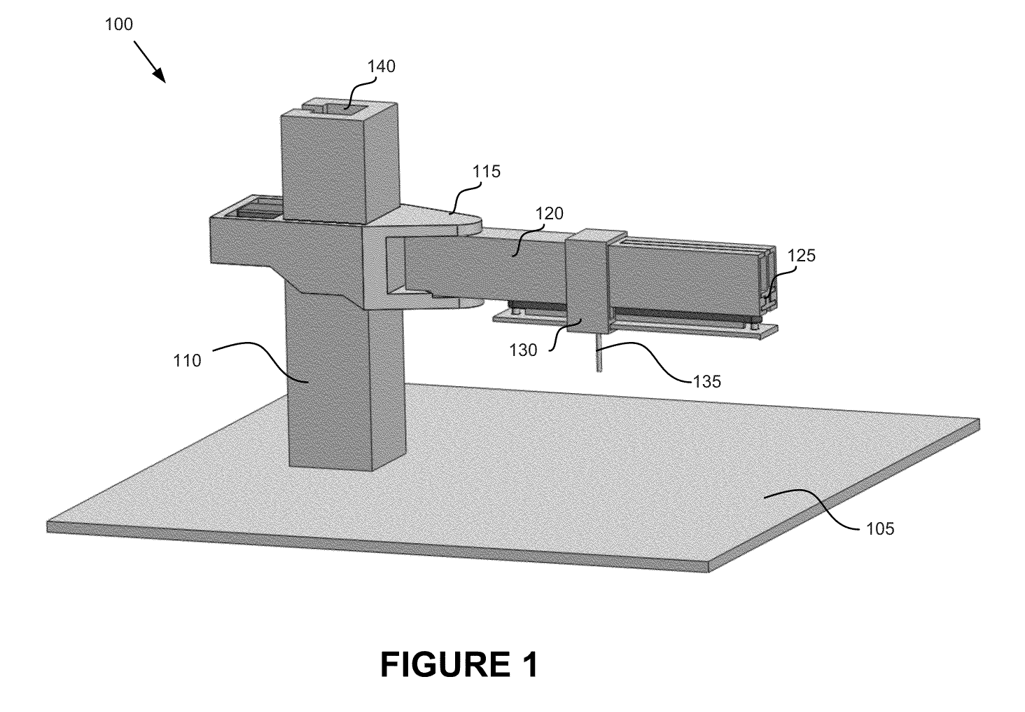

FIGS. 1 through 7 depict various embodiments of 3D printing devices that may extrude the 3D printing material in a unique way. Whereas existing 3D printing devices move the extruder assembly of the 3D printing devices using a Cartesian coordinate system of x and y axes at right angles to each other, embodiments shown in FIGS. 1 through 7 may instead be configured to move the extruder assembly in a polar coordinate system of an angle θ and a radius r. Whereas other 3D printers' software ultimately gives signals to motors that move mechanical elements along x- and y-axes, the embodiments of FIGS. 1 through 7 may instead be configured to give software inputs to motors controlling angular rotation in the angle θ and extension/contraction of a radial arm.

In embodiments, the angular movement may be achieved by rotating the orientation of a generally horizontal beam through actuation of a motor affixed to a gear. The radial r movement may be achieved by extending and contracting a telescoping arm driven by a single motor. The part of the telescoping arm to which the extruder assembly is attached may slide overtop of the rest of the telescoping arm, giving the extruder assembly access to radii smaller than that of the length of the most collapsed configuration of the telescoping arm. In other embodiments, the extruder assembly may be attached to a fixed point of the arm, and the arm may move laterally with respect to the column.

FIGS. 1 through 7 also depict embodiments of a 3D printing device that may move the extruder assembly vertically along the z-axis along a single column. In other embodiments, other 3D printers may have multiple columns to suspend the extruder assembly above the 3D part being printed. In embodiments, the entire rotating/telescoping arm assembly may move up or down a fixed vertical column that is affixed to a solid base upon which the 3D printed part is made. In one embodiment, the column may have a U-shaped horizontal cross-section. Vertical motion in the z-direction may be achieved by a motor driving two pinion gears that move against two fixed rack gears on the interior surface of the U-shaped column. In other embodiments, the column may be generally hollow or semi-hollow, and include a lead screw coupled with the beam. Movement in the z-direction may be achieved by rotation of the lead screw.

An embodiment of a 3D printing device 100 is shown in FIG. 1. A column 110 may be affixed to a base 105. In embodiments, the column 110 may be a vertical column, and may form a right angle with respect to base 105. In other embodiments, the column 110 may be tilted with respect to the base 105 so that the column 110 is not vertical. A climber 115 may be coupled with the column 110 such that the climber 115 is angularly fixed with regards to the column 110. That is, the climber 115 may not angularly rotate with respect to the column 110. However, the climber 115 may still be configured to slide vertically up and down the column 110.

The column 110 may have a substantially U-shaped cross-section formed by a hole or cut-out 140 (hereinafter hole 140) within the interior and the backside of the column 110. In other embodiments, the column 110 may have an alternative cross-sectional shape, for example circular or rectangular. In other embodiments, the hole 140 may have an alternative cross-sectional shape, while in other embodiments the hole 140 may not be present in some or all of the column 110. Additionally, in other embodiments, the 3D printing device 100 may include multiple columns, and more than one column may be attached to a climber 115. For example, in some embodiments the climber 115 may be suspended between one or more columns.

A beam 120 may be coupled with the climber 115. As shown in FIG. 1, the beam may be generally rectangular in cross-section, though in other embodiments the beam may have an alternative cross-section, for example a rounded cross-section or some other cross-section.

An I-beam 125 may be positioned at least partially within the beam 120. In some embodiments, and as will be discussed in greater detail below, the I-beam 125 may be configured to extend from the beam 120 to extend the radius of the 3D printing device 100. Additionally, as noted below, in some embodiments the I-beam 125 may have an alternative cross-sectional shape. The term “I-beam” is used herein for convenience, but should not be construed as specifically limiting the cross-sectional structure of the beam.

An extruder assembly 130 may be coupled with the beam 120. Specifically, the extruder assembly 130 may be configured to move laterally with respect to the beam 120. In other words, the extruder assembly 130 may be configured to move laterally either closer to or farther from the column 110. If the I-beam 125 is extended from the beam 120, then the extruder assembly 130 may be further configured to move along the extended I-beam 125 to move even further from the column 110. The extruder assembly 130 may include one or more of a gear, a motor, a heating element, circuitry, a nozzle, or other elements. As shown in FIG. 1, the extruder assembly 130 may deposit a portion of 3D printing material 135 from the extruder assembly 130, for example after heating by a heating element and extrusion through a nozzle of the extruder assembly 130, as described in greater detail below.

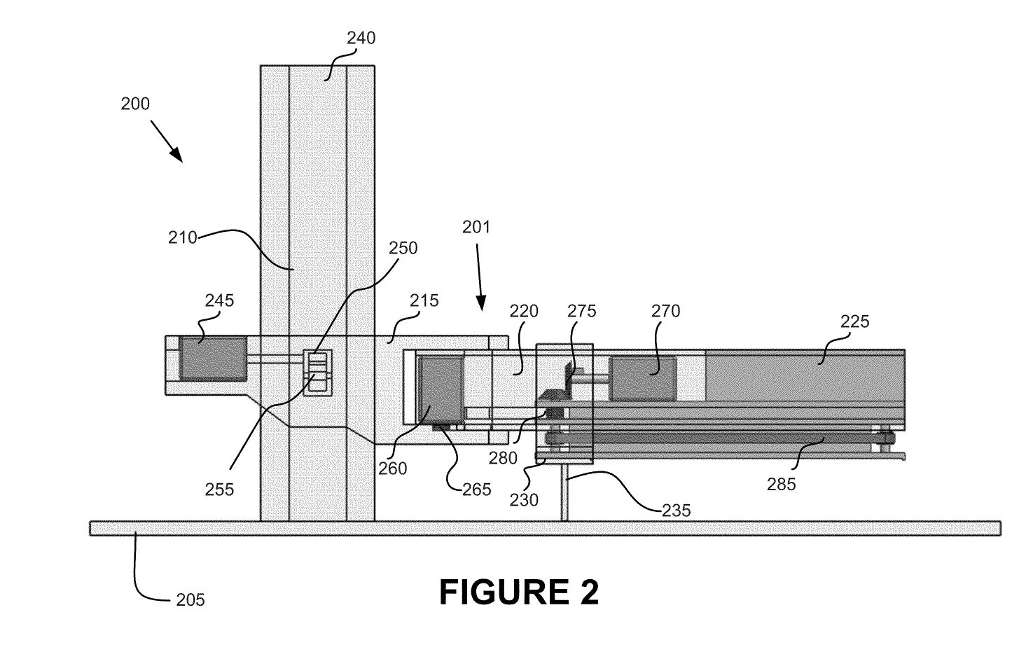

FIG. 2 depicts a semi-transparent side view of a 3D printing device 200 which may be similar to the 3D printing device 100 described above. Similarly numbered elements may be similar to one another. Specifically, the 3D printing device 200 may include a base 205, a column 210, a climber 215, a beam 220 with an I-beam 225 generally positioned within, and extruder assembly 230 configured to extrude a 3D printing material 235, and a hole 240 in the column 210.

In one embodiment, an extension of the climber 215 may be positioned within the hole 240 of the column 210. Within this extension, a pinion gear assembly 255 of the climber 215 may be mated to two identical inward facing rack gears 250 coupled with or machined into the column 210. For example, the rack gears 250 may be coupled with the front and back faces of the hole 240. In other embodiments, a single rack gear or more than two rack gears may be mated with a single pinion gear or more than two pinion gears. In some embodiments, a drive belt may be used in lieu of or in conjunction with a gear or gears.

The climber 215 may move up or down the column 210 by operation of a motor 245, which may be affixed to the climber 215. The motor 245 may turn one or both of the gears of the pinion gear assembly 255, which in turn drives the pinion gear assembly 255 along the rack gears 250. In embodiments where the rack gears 250 are on opposite faces of the hole 240, the gears of the pinion gear assembly 255 may move in opposite directions from one another. In embodiments where the gears of the pinion gear assembly 255 are linear, that is connecting with a single rack gear 250, the gears may move in the same direction as one another. In other embodiments, other gear assemblies may be used. For example, gear assemblies using methods other than a rack and pinion (such as a rotating threaded screw, a belt system or others) may be used to cause climber 215 to move vertically.

In embodiments, the extruder assembly 230 may be configured to rotate angularly around angle θ through angular rotation of the beam 220 with respect to the column 210. Specifically, the beam 220 may angularly rotate with its axis of rotation intersecting with the climber 215 as shown in FIG. 2 at pivot point 201. Specifically, motor 260, which may be affixed to the beam 220, may turn pinion gear 265 along an arced rack gear (not shown) machined into the upper surface of the lower brace of the climber 215. In other embodiments, the pinion gear 265 and the arced rack gear (not shown) may be on other surfaces of one or both of the beam 220 and/or the climber 215, for example the lower surface of the upper brace of the climber 215, or on an outside surface of the climber 215.

As described above, one or both of I-beam 225 and extruder assembly 230 may move radially along the axis of the beam 220. In one embodiment, a motor 270, which may be affixed to the I-beam 225 may rotate a gear 275. The gear 275 may, in turn, rotate axle 280 and its attached gear, which in some cases may be a pinion gear. The pinion gear coupled with the axle 280 may move along a rack gear coupled with an interior face of the beam 220. This movement of the pinion gear along the rack gear may cause the I-beam 225 to move inward or outward with respect to the beam 220. Although some embodiments use an I-beam, the use of the term “I-beam” with regard to the I-beam 225 is only descriptive of one embodiment, and the I-beam 225 may have other cross-sectional shapes or structures in other embodiments.

The axle 280 may also drive a belt 285, which may be affixed to the extruder assembly 230. As the belt 285 moves, the extruder assembly 230 may move horizontally along the outside of one or both of the beam 220 and/or I-beam 225. In some embodiments, the axle 280 may be configured to drive the belt 285 while being disengaged from the pinion gear coupled with the axle 280. Additionally or alternatively, the axle 280 may be operable to drive the pinion gear coupled with the axle 280 while it is disengaged from the belt 285. In some embodiments, the axle 280 may simultaneously drive both the belt 285 and the pinion gear coupled with the axle 280.

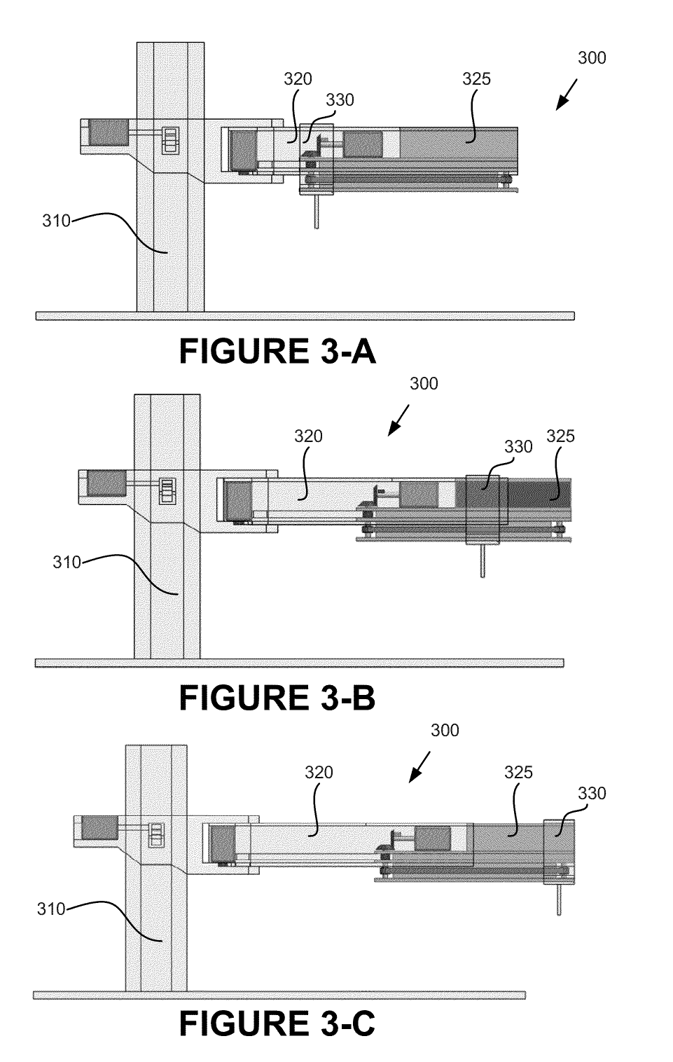

FIGS. 3-A through 3-C depict 3D printing devices 300 which may be similar to the 3D printing devices 100 or 200. Similarly numbered elements may be similar to elements in other Figures. Specifically, the beam 320 may be similar to beams 120 or 220. I-beam 325 may be similar to I-beams 125 or 225. Extruder assembly 330 may be similar to extruder assemblies 130 or 230. Column 310 may be similar to columns 110 or 210.

FIG. 3-A depicts an example of the 3D printing device 300 where the I-beam 325 may be fully within the beam 320, and the extruder assembly 330 may be relatively close to the column 310. FIG. 3-B depicts an example of the 3D printing device 300 where the I-beam 325 may be at least partially extended from the beam 320, and the extruder assembly may be near the end of the beam 320 that is furthest from the column 310. FIG. 3-C depicts the 3D printing device 300 where the I-beam 325 may be at least partially extended from the beam 320, and the extruder assembly 330 may be positioned on the I-beam 325.

As shown in FIGS. 3-A through 3-C, the combined radial motion of the I-beam 325 within the beam 320, and the extruder assembly 330 along the outside of rectangular beam 320 and I-beam 325 may allow the extruder assembly 330 to move from a position relatively close to the column 310, to a position farther from the column 310 than the far end of the beam 320. This radial extension may translate into extended radial range of motion for the extruder assembly 330.

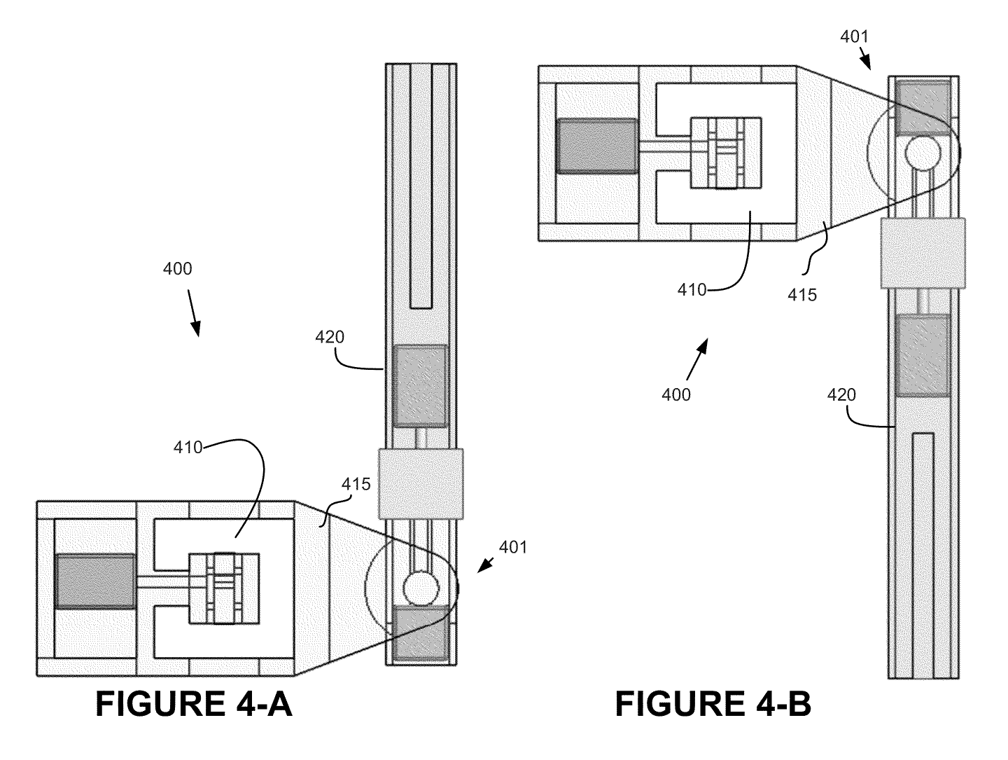

FIGS. 4-A and 4-B depict top down views of 3D printing devices 400 which may be similar to the 3D printing devices 100, 200, or 300. Similarly numbered elements may be similar to elements in other Figures. Specifically, the column 410 may be similar to columns 110 or 210. Climber 415 may be similar to climbers 115 or 215. Beam 420 may be similar to beams 120 or 220. Pivot point 401 may be similar to pivot point 201.

As described above, the beam 420 may be configured to angularly rotate around pivot point 401 with respect to the column 410 and climber 415. FIGS. 4-A and 4-B depict the beam 420 angularly rotated with respect to the column 410 in opposite directions, describing a roughly 180° arc. In other embodiments, the beam 420 may be able to pivot to a greater or lesser degree.

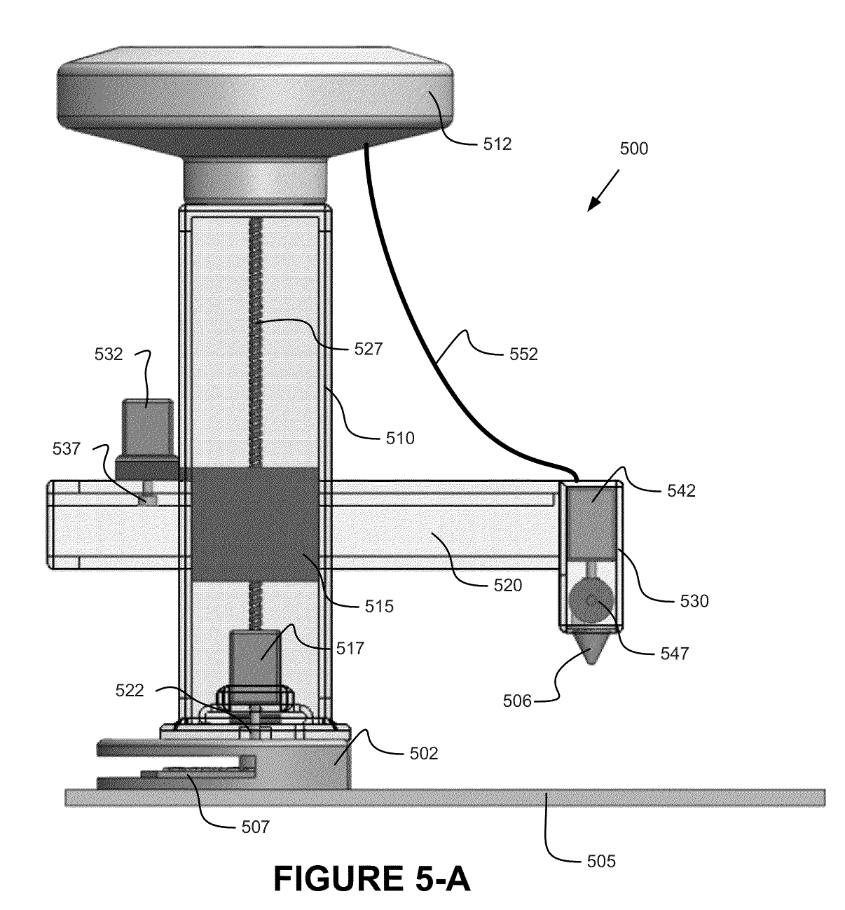

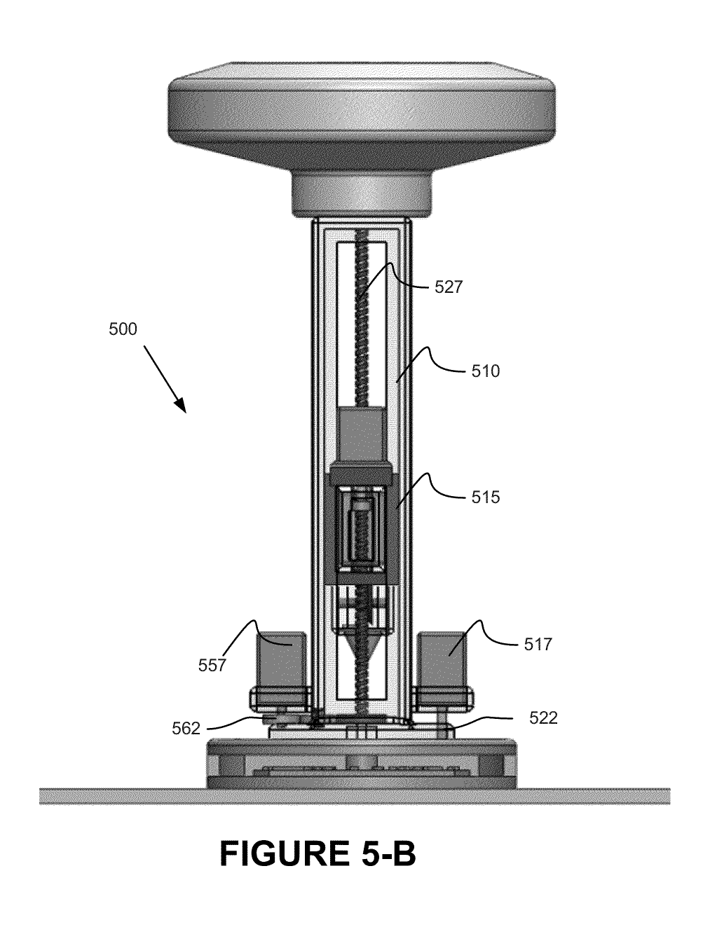

FIG. 5-A depicts a semi-transparent side view of an alternative embodiment of a 3D printing device 500. FIG. 5-B depicts a semi-transparent side view of the 3D printing device 500. In this embodiment a platform 502 may be affixed to a base 505. A circuit board 507 may be affixed within a cavity inside of the platform 502, or located elsewhere but communicatively coupled with the 3D printing device 500. A column 510 may be coupled with the platform 502 such that it may angularly rotate in the horizontal plane, but may not move or rotate in any other direction. However, in other embodiments the column 510 may be hinged such that it may tilt with respect to the platform 502. A climber 515 may be coupled with the column 510 such that it may be able to move up or down with respect to the column 510, but may not be able to move or rotate in any other direction independent of the movement or rotation of the column 510. However, in other embodiments, the climber 515 may be able to rotate with respect to the column 510. A beam 520, which may be hollow and contain one or more elements such as a rack gear affixed to the inside of the beam, may be coupled with the climber 515 such that it may move horizontally with respect to the climber 515, but it may not be able to move or rotate in any other direction independent of the movement or rotation of the climber 515. However, in other embodiments, the beam 520 may be hinged such that it is able to move vertically or rotate with respect to the climber 515.

An extruder assembly 530 may be affixed to the beam 520. As shown in FIG. 5-A, the extruder assembly 530 may be affixed to the beam 520 at an end of the beam 520. However, in other embodiments the extruder assembly 530 may be affixed to the beam 520 at another point along the beam. In some embodiments, a plurality of extruder assemblies 530 may be affixed to the beam 520. A material cartridge 512 may be affixed to the column 510, for example the top of the column 510. In other embodiments the material cartridge 512 may be attached to a different portion of the column 510, coupled with the platform 502 or base 505, attached to a different portion of the 3D printing device 500, or entirely separate from the 3D printing device 500.

The column 510 may angularly rotate relative to the platform 502 based at least in part on the operation of a motor such as motor 517. The motor 517 may be affixed to the base of the column 510, and may be operable to rotate a pinion gear such as gear 522 along an arced rack gear recessed into the top of the platform 502. Rotation of the gear 522 in one direction may cause the column 510, and the attached assembly components described above, to angularly rotate in the clockwise direction with respect to the platform 502 and/or base 505. Rotation of the gear 522 in another direction may likewise cause the column 510 and the attached assembly components described above to angularly rotate in the counterclockwise direction. Other embodiments may include additional motors. Alternatively, the motor 517 may be attached to a different area of the 3D printing device 500, or even separate from the 3D printing device 500 but attached to the column 510, for example by a belt drive.

In one embodiment, the climber 515 may move vertically due to operation of a motor such as motor 557. The motor 557 may be affixed to the base of the column 510, and may be configured to rotate a gear train such as gear train 562, which in turn may cause a lead screw such as lead screw 527 to rotate. The climber 515 may be coupled with the lead screw 527 such that rotation of the lead screw 527 in one direction causes the climber 515 to move upward, and rotation of the lead screw 527 in another direction causes the climber 515 to move downward. In other embodiments the motor 557 may be coupled directly with the lead screw 527. In still other embodiments the climber 515 may be configured to move vertically according to or based on other configurations such as the rack and pinion assembly described above with respect to the 3D printing devices 100 and 200 or by another method such as a drive belt.

Beam 520 may move horizontally with respect to the base 505 and column 510 through operation of a motor such as motor 532. Motor 532 may be affixed to a top portion of the climber 515, and configured to rotate a pinion gear such as gear 537 along a rack gear affixed along a face such as an inside face of the beam 520. Rotation of the gear 537 in one direction may cause the beam 520 to move to the right (when the 3D printing device 500 is viewed from one side), and rotation of the gear 537 in another direction may cause the beam 520 to move to the left (when the 3D printing device 500 is viewed from the same side). This movement may be viewed as extension or contraction of the beam 520 with respect to the column 510. In other embodiments, the motor 532 may be placed at a different location with respect to the beam 520, climber 515, and/or column 510.

An extruder assembly 530 may be similar to the extruder assembly described above such as, for example, extruder assembly 130, and coupled with the beam 520 as described above. The extruder assembly 530 may be configured to add material to a 3D printed part. Specifically, a continuous strand of build material 552 may flexibly extend from the material cartridge 512 to the top of the extruder assembly 530. To apply the build material 552 to the 3D printed part, one or more components of the extruder assembly 530 such as the extruding nozzle 506, or a separate element of the extruder assembly 530 which is coupled with the extruding nozzle 506 may be heated to a temperature sufficient to melt the build material 552. For example, the extruding nozzle 506 may be heated to a temperature of at least 90 degrees Fahrenheit (32.2 degrees Celsius). Then, when the extruder assembly 530 is in the appropriate location to begin adding the build material 552, the motor 542 may rotate a gear or gear train 547 to feed build material 552 into the top of the extruding nozzle 506 (or alternatively, into the heating element). This process may continue while the 3D printing device 500 changes its orientation via radial, angular or vertical rotations and movements described above with respect to 3D printing devices 100, 200, 300, or 400 to move the extruder assembly 530 along a desired path in 3D space. As noted above, the material cartridge 512 may be attached at a different point with regard to the column 510, or the extruding assembly 530. For example, the material cartridge 512 may be entirely separate from the 3D printing device 500, but still situated such that build material 552 may extend from the material cartridge 512 to the extruding assembly 530. In some embodiments, the extruder assembly may be separated into one or more parts (not shown in FIG. 5-A). Specifically, the motor 542 and/or gear train 547 may be affixed to another part of the 3D printer 500, or completely separate from the 3D printer 500, than the extruding nozzle 506. For example, in some cases the motor 542 and/or gear train 547 may be located relatively close to the material cartridge 512, and configured to push build material 552 into the extruding nozzle 506, which may still be located near the end of beam 520 as shown in FIG. 5-A.

In embodiments, all three axes of motion (vertical ‘z’, radial ‘r’, and angular ‘theta’) of the 3D printing devices 100, 200, 300, 400, and 500 may move independently of each other, allowing the point at which 3D printed material leaves the extruding assembly to move within a very large 3-dimensional volume when compared to the size of 3D printing device 100.

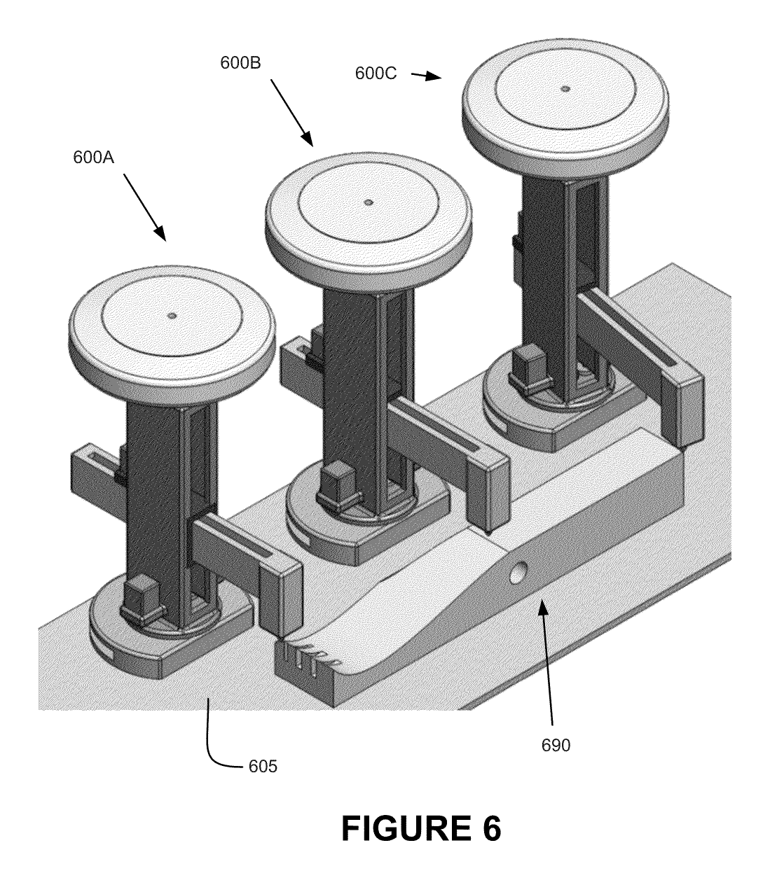

FIG. 6 depicts an example of a plurality of 3D printing devices 600A, 600B, and 600C operating together to construct a single 3D printed part 690. In embodiments, the 3D printing devices 600A, 600B, and 600C may all be attached to the same base 605, while in other embodiments one or more of the 3D printing devices 600A, 600B, and 600C may be attached to a separate base. Additionally, although each of the 3D printing devices 600A, 600B, and 600C are shown arranged in a roughly linear fashion, in other embodiments one or more of the 3D printing devices may be generally across from or opposite another one of the 3D printing devices. As shown in FIG. 6, the 3D printing devices 600A, 600B, and 600C are similar to the 3D printing device 500 depicted in FIGS. 5-A and 5-B. In other embodiments one or more of the 3D printing devices 600A, 600B, and 600C may instead be similar to one of 3D printing devices 100, 200, 300 or 400.

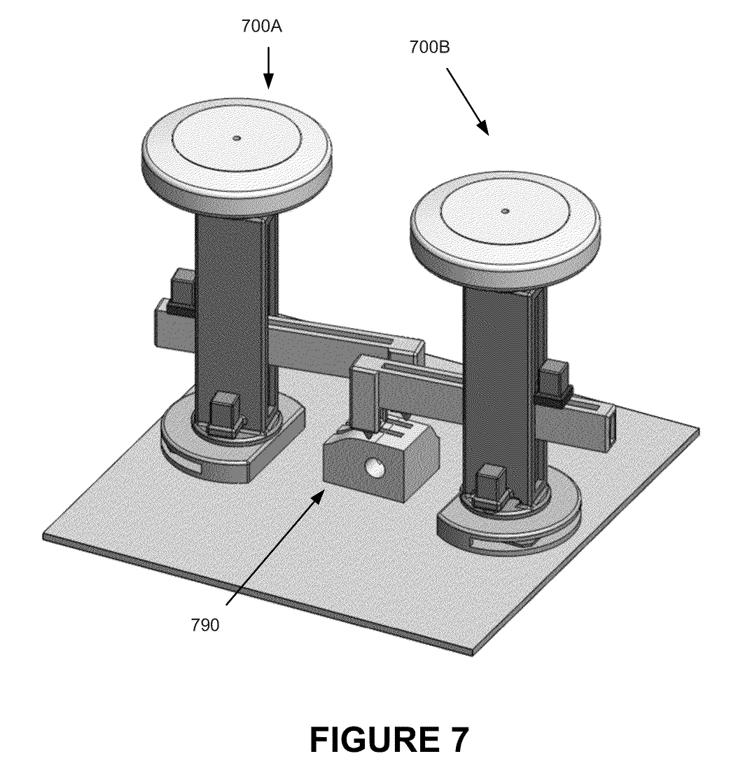

Although three 3D printing devices 600A, 600B, and 600C are depicted in FIG. 6, in other embodiments more or fewer 3D printing devices may be networked together. For example, FIG. 7 depicts an example of two 3D printing devices 700A and 700B networked together to construct a 3D printed part 790. As described above, the 3D printing devices 700A and 700B may be configured in a linear or opposite fashion. Additionally, one or more of the 3D printing devices 700A and 700B may be similar to any of 3D printing devices 100, 200, 300, 400, or 500.

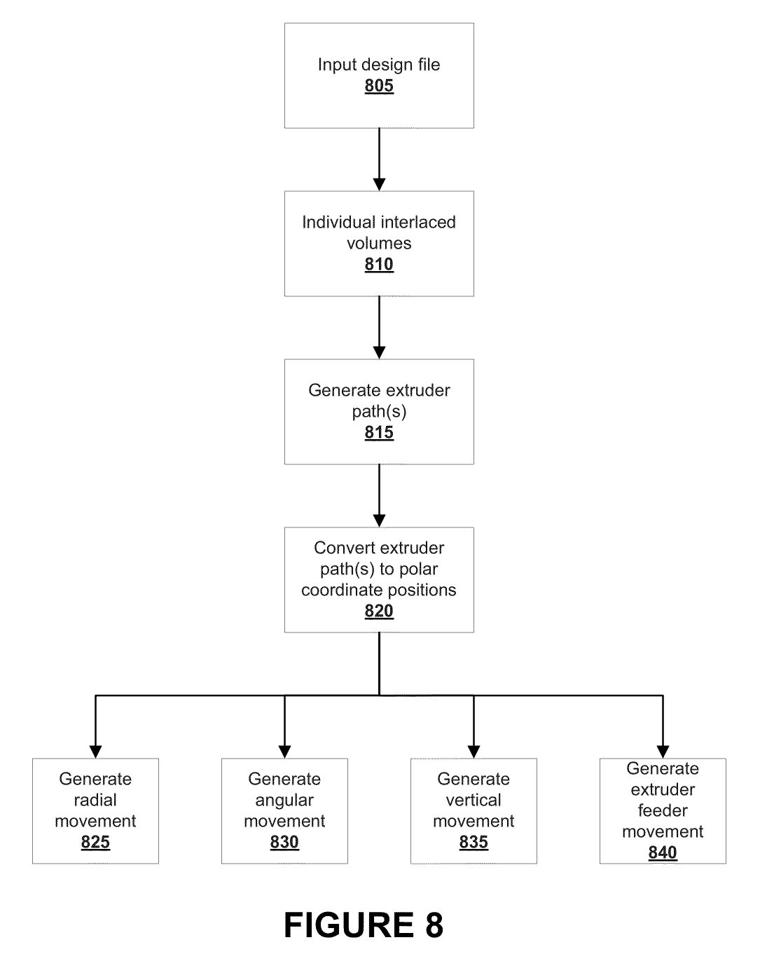

FIG. 8 depicts an embodiment of a logical process that may be used by one or more embodiments of a 3D printing device such as 3D printing devices 100, 200, 300, 400, 500, 600A-C, or 700A-B when making a 3D printed part such as parts 690 or 790. An input design file, which may be an output of a computer aided design (CAD) program or some other design program, may be digitally interpreted by one or several elements of computer software at 805. In embodiments, and as described above, the input design file may include instructions according to Cartesian, that is X-Y, coordinates. The input design file may be used to generate one or more interlaced volumes at 810. Each interlaced volume may correspond to one or more 3D printing devices, for example 3D printing devices 100, 200, 300, 400, 500, 600A-C, or 700A-B. One or several elements of computer software may then generate individual extruder paths at 815. As stated above, each path may correspond to one or more of the 3D printing devices being used, and the paths may include timing sequences to keep individual 3D printing devices from colliding during the build process if multiple 3D printing devices are being used. The paths and timing may therefore define the paths that the individual extruders may follow to create the desired shape.

As noted above, the input design file may include Cartesian coordinates, and so the output extruder paths may then be converted into a series of polar coordinate positions at 820 using one or several elements of computer software. Finally, these polar coordinate positions may be converted into inputs to motors to generate radial movement at 825, angular movement at 830, and/or vertical movement at 835 of an embodiment of a 3D printing device. A signal may also be generated using one or several elements of computer software for movement of the material cartridge 512 or one or more elements of the extruder assembly 530 to feed build material 552 into the extruder assembly 530, or extrude build material 552 from the extruding nozzle 506 to apply material to a 3D part being constructed at 840.

The movements generated at 825, 830, 835, and/or 840 in concert may cause the extruding assembly of a 3D printing device to follow the extruder path and apply material and thereby create the desired shape. As described above, in some embodiments, the conversion at 820 may be unnecessary because the design file may already contain the extruder path in polar coordinates. Some or all of the computational processing and/or electrical signal generation described herein may occur in an electrical circuit or on a circuit board such as the circuit board 507 described above with respect to FIG. 5-A. Alternatively, this computational processing may occur on a remote computer, server, tablet computer, smartphone or a network of computers, servers, tablet computers and/or smartphones.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. An apparatus comprising:
a base;
a column coupled with the base;
a climber coupled with the column, the climber configured to traverse the column;
a beam coupled with the climber;
an extruder coupled with the beam and configured to extrude a three-dimensional (3D) printing material, the extruder further configured to be angularly repositionable with respect to the base, the extruder further configured to be laterally repositionable with respect to the column.

2. The apparatus of claim 1, wherein the column is a vertical column.

3. The apparatus of claim 1, wherein the beam is a horizontal beam.

4. The apparatus of claim 1, wherein the column is configured to be angularly repositionable with respect to the base.

5. The apparatus of claim 1, wherein the beam includes a first end and a second end opposite the first end, and wherein the first end is coupled with the climber.

6. The apparatus of claim 5, where the beam is a first beam and further comprising a second beam positioned substantially inside of the first beam and configured to extend laterally beyond the second end of the first beam;
wherein the extruder is further configured to move laterally onto the second beam when the second beam extends beyond the second end of the first beam.

7. The apparatus of claim 6, wherein the second beam is an I-beam.

8. The apparatus of claim 1, wherein the beam is configured to be laterally repositionable with respect to the column, and the extruder is fixedly attached to the beam.

9. The apparatus of claim 1, wherein the column is a first column, the climber is a first climber, the beam is a first beam, and the extruder is a first extruder, the apparatus further comprising:
a second column coupled with the base;
a second climber coupled with the second column, the second climber configured to traverse the second column;
a second beam coupled with the second climber; and
a second extruder coupled with the second beam and configured to extrude a three-dimensional (3D) printing material, the second extruder further configured to be angularly repositionable with respect to the base, the second extruder further configured to be laterally repositionable with respect to the second column.

10. The apparatus of claim 9, wherein the first extruder has a first print area and the second extruder has a second print area, and wherein the first print area and the second print area at least partially overlap.

11. The apparatus of claim 1, further comprising:
a rack gear coupled with the column; and
a pinion gear coupled with the climber and in contact with the rack gear, the pinion gear configured to rotate with respect to the rack gear.

12. The apparatus of claim 1, further comprising a lead screw coupled with the column, the lead screw further coupled with the climber.

13. A method comprising:
identifying, by a processor, a Cartesian extruder path of a three-dimensional (3D) printer from a design file;
translating, by the processor, the Cartesian extruder path to a polar extruder path; and
generating, by the processor, movement of an extruder of the 3D printer based at least in part on the polar extruder path.

14. The method of claim 13, wherein the movement is radial movement of the extruder.

15. The method of claim 13, wherein the movement is angular movement of the extruder.

16. The method of claim 13, wherein the movement is vertical movement of the extruder.
